(19) United States
(12) Patent Application Publication
(10) Pub. No.: US 2013/0058910 A1
(43) Pub. Date: Mar. 7, 2013

(54) DECONTAMINATION OF CHEMICAL AND BIOLOGICAL AGENTS

(71) Applicants: Richard Koepsel, Pittsburgh, PA (US); Gabriel Amitai, Rehovot (IL); Alan J. Russell, Gibsonia, PA (US); Hironobu Murata, Pittsburgh, PA (US)

(72) Inventors: Richard Koepsel, Pittsburgh, PA (US); Gabriel Amitai, Rehovot (IL); Alan J. Russell, Gibsonia, PA (US); Hironobu Murata, Pittsburgh, PA (US)

(21) Appl. No.: 13/406,508

(22) Filed: Feb. 27, 2012

Related U.S. Application Data
(60) Provisional application No. 61/447,260, filed on Feb. 28, 2011.

(51) Int. Cl. A62D 3/30; A01P 1/00; C08F 220/56; A01N 37/46

(52) U.S. Cl. 424/94.2; 510/110; 525/329.4

(57) ABSTRACT

A system includes at least one oxidase. at least one haloperoxidase; at least a first polymer including groups exhibiting nucleophilic activity for organophosphorus compounds, and a source of halide ions to serve as a substrate for haloperoxidase-catalyzed generation of halogens. The source of halide ions may, for example, include salt crystals or a salt in an extended release system. In a number of embodiments, the first polymer includes halide ions.

### CROSS-REFERENCE TO RELATED APPLICATIONS

This application claims benefit of U.S. Provisional Patent Application Ser. No. 61/447,260, filed Feb. 28, 2011, the disclosure of which is incorporated herein by reference.

### BACKGROUND OF THE INVENTION

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Weapons of mass destruction pose grave threats to society. In response to these threats, scientists have long searched for environmentally benign approaches to decontamination of both biological and chemical agents. Because it is difficult to predict what type of agent has been deployed (or if multiple agents have been deployed), it is desirable to develop broad-spectrum decontaminants that are simple to use, that are active against both chemical and biological agents, and that do not substantially adversely affect the environment into which they are deployed. However, there has been very limited, success in developing such broad-spectrum decontaminants.

### SUMMARY OF THE INVENTION

In one aspect, a system includes at least one oxidase. at least one haloperoxidase, at least a first polymer including groups exhibiting nucleophilic activity for organophosphorus compounds, and at least one source of halide ions to serve as a substrate for haloperoxidase-catalyzed generation of halogens. The source of halide ions may, for example, include salt crystals or a salt in an extended release system. In a number of embodiments, the first polymer includes halide ions to provide a source of halide ions as a substrate for the haloperoxidase.

The oxidase may, for example, be glucose oxidase. However, any oxidase suitable to catalyze a reaction to form a peroxide is generally suitable for use herein. For example, alcohol oxidases may also be used. Other suitable oxidases include, but are not limited to, NADH oxidases (nicotinamide adenine dinucleotide phosphate-oxidases), cytochrome c oxidases, xanthine oxidases, polyamine oxidases, glyoxal oxidases, and monoamine oxidases. The haloperoxidase may, for example, be a heme-containing peroxidase such as horseradish peroxidase. However, any haloperoxidase suitable to catalyze a reaction to generate halogens is generally suitable for use herein. Examples of other suitable haloperoxidases include, but are not limited to, chloroperoxidases, bormoperoxidases, vanadium peroxidases and dehaloperoxidase.

In a number of embodiments, the oxidase and the haloperoxidase are incorporated within a polymeric matrix including at least a second polymer. The oxidase and the haloperoxidase may, for example, be electrospun from a solution including the second polymer. The solution may, for example, also include the first polymer. The first polymer and the second polymer may, for example, be electrospun into a nonwoven matrix. In a number of embodiments, the second polymer is a polyurethane.

The groups exhibiting nucleophilic activity may, for example, include an oxime group. In a number of embodiments, the groups exhibiting nucleophilic activity include at least one group having the formula:

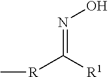

wherein R is an aryl group and R¹ is H or a C₁-C₁₅ alkyl group. R may, for example, include a quaternary ammonium group. In a number of embodiments, R includes and aryl group. In a number of embodiments, the groups exhibiting nucleophilic activity include at least one group have the formula:

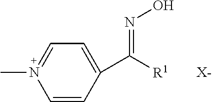

wherein X is a halide ion. In a number of embodiments, X is Br or I.

The groups exhibiting nucleophilic activity may, for example, be attached to the first polymer via a degradable or cleavable group. In a number of embodiments, the groups exhibiting nucleophilic activity are attached to the first polymer via a degradable group. The degradable group or cleavable group may, for example, be a group adapted to undergo hydrolysis (for example, an ester group or a peptide group).

In a number of embodiments, the first polymer further comprises groups adapted to form a reactive radical upon application of energy. The groups adapted to form a reactive radical upon application of energy may, for example, include benzophenone groups, acetophenone groups, benzyl groups, benzoin groups, hydroxyalkylphenone groups, phenyl cyclohexyl ketone groups, anthraquinone groups, trimethyl-benzoylphosphine oxide groups, methylthiophenyl morpholine ketone groups, aminoketone groups, azobenzoin groups, thioxanthone groups, hexaarylbisimidazole groups, triazine groups, or fluoroenone groups. Such groups, for example, enable crosslinking upon application of energy (for example, UV energy).

Further, azide-alkyne Click chemistry in which azide groups (—R²—N₃) are reacted with alkyne groups, (for example, straight or branched chain hydrocarbon groups with at least one triple bond, with, for example, 2-15 carbon atoms or 2-10 carbon atoms and having the general formula ≡R³) may be used to effect crosslinking. Alkyne groups and azide groups may, for example, be present on different polymers which are to be crosslinked. In general, any terminal azide group can be reacted with any alkyne

In a number of embodiments, the first polymer is the reaction product of a radical polymerization of radically polymerizable monomers. The monomers may, for example, be selected from acrylates, methacrylates, acrylamides, methacrylamides, styrenes or combinations thereof.

In another aspect, a polymer includes groups exhibiting nucleophilic activity for organophosphorus compounds and halide ions (for example, to serve as a substrate for enzyme-catalyzed generation of halogens). The groups exhibiting nucleophilic activity may, for example, include an oxime group. In a number of embodiments, the groups exhibiting nucleophilic activity include at least one group having the formula:

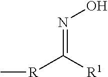

wherein R is an aryl group and R¹ is H or a C₁-C₁₅ alkyl group. R may, for example, include a quaternary ammonium group. In a number of embodiments, R is a pyridinium group such that the groups exhibiting nucleophilic activity include at least one group have the formula:

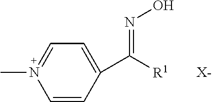

wherein X is a halide ion. In a number of embodiments, X is Br or I.

As described above, the groups exhibiting nucleophilic activity are attached to the polymer via a degradable group. The degradable group may, for example, be a group adapted to undergo hydrolysis.

The polymer may, for example, further include groups adapted to form a reactive radical upon application of energy. The groups adapted to form a reactive radical upon application of energy may, for example, include at least one of: benzophenone-, acetophenone-, benzyl-, benzoin-, hydroxyalkylphenone-, phenyl cyclohexyl ketone-, anthraquinone-, trimethyl-benzoylphosphine oxide-, methylthiophenyl morpholine ketone-, aminoketone-, azobenzoin-, thioxanthone-, hexaarylbisimidazole-, triazine-, or fluoroenone-.

The polymer may, for example, be the reaction product of a radical polymerization of radically polymerizable monomers. In a number of embodiments, the monomers are selected from acrylates, methacrylates, acrylamides, methacrylamides, styrenes or combinations thereof.

In another aspect, a polymer includes groups exhibiting nucleophilic activity for organophosphorus compounds which are attached to the polymer via a degradable or cleavable bond.

The groups exhibiting nucleophilic activity may, for example, include an oxime group. In a number of embodiments, the groups exhibiting nucleophilic activity include at least one group having the formula:

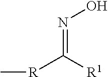

wherein R is an aryl group and R¹ is H or a C₁-C₁₅ alkyl group. R may, for example, include a quaternary ammonium group. In a number of embodiments, R includes and aryl group. In a number of embodiments, the groups exhibiting nucleophilic activity include at least one group have the formula:

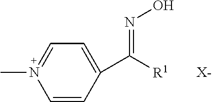

wherein X is a halide ion. In a number of embodiments, X is Br or I.

The degradable group or cleavable group may, for example, be a group adapted to undergo hydrolysis (for example, an ester group or a peptide group).

In a number of embodiments, the polymer further comprises groups adapted to form a reactive radical upon application of energy. The groups adapted to form a reactive radical upon application of energy may, for example, include benzophenone groups, acetophenone groups, benzyl groups, benzoin groups, hydroxyalkylphenone groups, phenyl cyclohexyl ketone groups, anthraquinone groups, trimethyl-benzoylphosphine oxide groups, methylthiophenyl morpholine ketone groups, aminoketone groups, azobenzoin groups, thioxanthone groups, hexaarylbisimidazole groups, triazine groups, or fluoroenone groups. Such groups, for example, enable crosslinking upon application of energy (for example, UV energy).

Further, azide-alkyne Click chemistry in which azide groups (—R²—N₃) are reacted with alkyne groups, (for example, straight or branched chain hydrocarbon groups with at least one triple bond, with, for example, 2-15 carbon atoms or 2-10 carbon atoms and having the general formula ≡R³) may be used to effect crosslinking. Alkyne groups and azide groups may, for example, be present on different polymers which are to be crosslinked. In general, any terminal azide group can be reacted with any alkyne

In a number of embodiments, the polymer is the reaction product of a radical polymerization of radically polymerizable monomers. The monomers may, for example, be selected from acrylates, methacrylates, acrylamides, methacrylamides, styrenes or combinations thereof.

In a further aspect, a polymer includes oxime groups. The oxime groups may, for example, exhibit nucleophilic activity for organophosphorus compounds. In a number of embodiments, polymer includes at least one group having the formula:

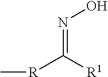

wherein R is an aryl group and R¹ is H or a C₁-C₁₅ alkyl group. R may, for example, include a quaternary ammonium group. In a number of embodiments, R includes and aryl group. In a number of embodiments, the polymer includes at least one group have the formula:

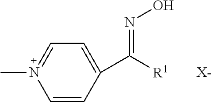

wherein X is a halide ion. In a number of embodiments, X is Br or I.

In still a further aspect, a method of providing for decontamination of both organophosphorus compounds and biological agents or microorganisms (for example, bacteria, viruses, and/or fungi) includes providing a system including at least one oxidase, at least one haloperoxidase, at least a first polymer including groups exhibiting nucleophilic activity for organophosphorus compounds, and a source of halide ions to serve as a substrate for haloperoxidase-catalyzed generation of halogens.

The present invention, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates an embodiment of a system including an oxidase, a haloperoxidase, and a polymer including groups exhibiting nucleophilic activity for organophosphorus compounds and halide ions to serve as a substrate for haloperoxidase-catalyzed generation of halogens.

FIG. 2 illustrates an embodiment of a synthetic scheme for synthesizing polymers including quaternary pyridinium aldoximes.

FIG. 3 illustrates an embodiment of a synthetic scheme for synthesizing polymers including quaternary pyridinium aldoximes, other quaternary ammonium groups and photoactivatable groups (benzophenone in the illustrated example).

FIG. 4 illustrates the release of N-hydroxy ethyl 4-Pyridinium aldoxime (HE 4-PAM) (2) from 4-PAM-bromide polymer 2 as a function of time at different pH values as compared to a mixture of 7 with polymer 1 (the non-quaternized precursor of polymer 2).

FIG. 5A illustrates reactivation of diisopropylfluorophosphate- (DFP-) inhibited acetylcholinesterase (AChE) by HE 4-PAM (2) and 4-PAM iodide (0.4 mM oxime in 50 mM phosphate pH 7.4, 22° C.) as a function of time.

FIG. 5B illustrates the rate of decrease in AChE inhibition during reactivation by oximes, wherein Iₒ=AChE inhibition at t=0 and Iₜ=AChE inhibition at time t during reactivation (symbols are as described in FIG. 1A); and wherein the rate constants (k_{obs}×10⁻³ min⁻¹) for HE-4-PAM and 4-PAM were 3.4 and 2.7, respectively.

FIG. 6A illustrates a scanning electron microscopy photograph of electrospun CHRONOFLEX® polyurethane (CF), available from Advansource Biomaterials Corporation of Wilmington, Mass., with the soluble polymer 4 before UV irradiation at 330-350 nm for 5 minutes.

FIG. 6B illustrates a scanning electron microscopy photograph of electrospun CF with the soluble polymer 4 after UV irradiation at 330-350 nm for 5 minutes.

FIG. 7 illustrates a graph of leaching of polymer 4 from CF-4 fibers as a function of time, wherein empty squares represent fibers not irradiated with UV radiation and empty triangles represent UV irradiated fibers.

FIG. 8A illustrates free bromine generation by GOX, HRP and polymer 2 incorporated by electrospinning into CF polyurethane as a function of time with differing amounts of redox enzymes.

FIG. 8B illustrates free iodine generation by GOX, HRP and polymer 4 incorporated by electrospinning into CF polyurethane as a function of time for non-UV treated fiber matrix and UV-irradiated fiber matrix, wherein UV irradiation was performed at 330-350 nm with a 13 cm distance for 5 minutes.

FIG. 9 illustrates DFP detoxification by polymer 2 dissolved in phosphate buffer (pH 7.5) over time at varying concentration, wherein samples were taken at indicated times and assayed for DFP detoxification.

FIG. 10 illustrates DFP (5×10⁻⁶ M) detoxification by polymer 4 over time measured for: 15 mg/ml solution of polymer 4 in dissolved in phosphate buffer (pH 7.5) (□); 15 mg/ml solution of polymer 4 in dissolved in phosphate buffer with GOX. HRP (0.01 mg/ml each) and glucose (5 mM) added to the buffer solution (A); or phosphate buffer alone (▾), wherein 20 μl aliquots were sampled at specified times and incubated with BChE for 3 minutes, and butyrylcholinesterase (BChE) activity was measured by the Ellman assay.

FIG. 11 illustrates DFP detoxification over time by insoluble fibers of polymer 4 electrospun with CF polyurethane, wherein a 15 mg electrospun fiber sample of CF-4 was immersed in a test tube with 5×10⁻⁶ M DFP in phosphate buffer (50 mM, pH 7.5), wherein samples were drawn at the indicated times and incubated for 3 minutes with BChE, and BChE activity was measured by the Ellman assay.

### DETAILED DESCRIPTION OF THE INVENTION

As used herein and in the appended claims, the singular forms “a,” “an”, and “the” include plural references unless the context clearly dictates otherwise. Thus, for example, reference to “an oxidase” includes a plurality of such oxidases and equivalents thereof known to those skilled in the art, and so forth, and reference to “the oxidase” is a reference to one or more such oxidases and equivalents thereof known to those skilled in the art, and so forth.

In a number of embodiments, systems hereof provide for broad-spectrum decontaminants which are active against both chemical (organophosphorus) agents and biological (for example, bacteria, viruses and spores) agents. Moreover, the systems hereof do not substantially adversely affect the environment into which they are deployed. The systems hereof may, for example, be combined into an integral material. In a number of embodiments, system hereof destroy biological and nerve agents relatively rapidly upon hydration.

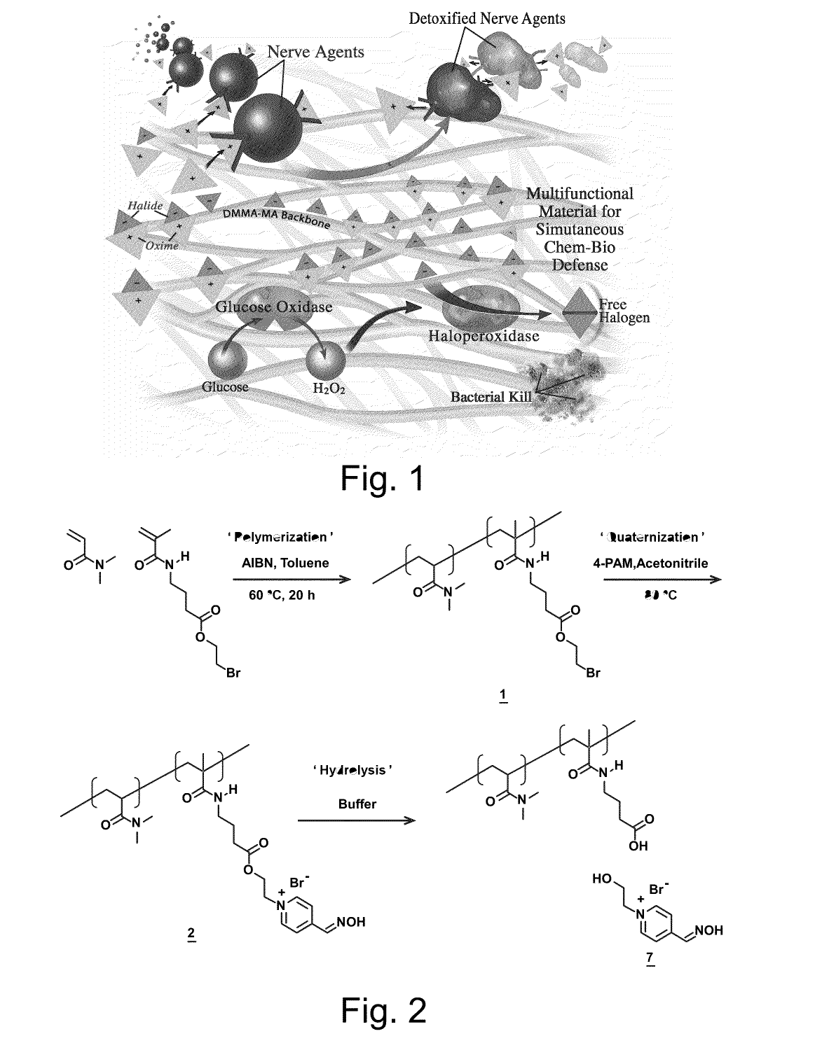

FIG. 1 provides a schematic representation of an embodiment of a multifunctional material or system hereof. The system of FIG. 1 generates biocidal halogens while, for example, releasing nerve agent detoxifying agents that may, for example, be used for decontamination or therapy. In the illustrated embodiment, the broad-spectrum decontamination system is activated in the presence of an oxidase enzyme substrate (for example, glucose) and water. The ready availability of glucose and water in blood and bodily fluids allows the system of FIG. 1 to, for example, be used internally or as a wound dressing. The system has the capacity to kill biological entities or microorganisms (for example, bacteria, viruses and even spores). Additionally, the multifunctional system of FIG. 1 may also include, and potentially release, entities including groups exhibiting nucleophilic activity for organophosphorus/organophosphate compounds. Such entities including groups exhibiting nucleophilic activity for organophosphorus compounds may, for example, be released in a controlled manner to combat the effects of, for example, cholinesterase inhibitors. In a number of embodiments, the groups exhibiting nucleophilic activity for organophosphorus compounds are oxime groups. In general, organophosphorus compounds are degradable organic compounds containing carbon-phosphorus bonds. Organophosphates are found both in insecticides, herbicides and certain chemical warfare agents.

The ability of halogens to kill a wide variety of microorganisms including antibiotic-resistant bacteria, viruses, and fungi has been known for centuries. For example, multiple isolates of methicillin-resistant Staphylococcus aureus (MRSA), a major nosocomial pathogen, have been shown to be susceptible to povidone iodine within 30 minutes at a minimal biocidal concentration of 512 ppm. Polyquaternary ammonium compounds spear-headed by positively charged quaternary ammonium units also exhibit remarkably broad bactericidal activity both in solution and when delivered from a surface. Oxime containing entities including, for example, aldoximes and ketoximes are reactivators of cholinesterases (ChE) inhibited by organophosphate (OP) toxins. For example, quaternary pyridinium aldoximes (for example, 2-pyridinealdoxime (2-PAM), 4-pyridinealdoxime (4-PAM), and 1,1′-oxybis-(methylene)bis-4-(hydroxyimino)methyl-pyridinium dichloride or toxogonin) are efficient reactivators of cholinesterases inhibited by organophosphate (OP) toxins. The interaction of pyridinium aldoximes with toxic OPs results in slow detoxification of the OP agent. This slow detoxification activity has been enhanced in polymers carrying nano-magnetoparticles complexed with oxime groups which displayed catalytic degradation of the nerve agent analog diisopropylfluorophosphate (DFP). Further, the addition of positively charged groups enhances the reaction rates of pyridinium oximes against toxic OPs through a “charge effect” that may, for example, increase the nucleophilic activity of the oxime group and results in reaction rates higher than calculated from Bronsted's law. In a number of embodiments hereof pyridinium oxime-halide (for example, PAM-halide) polymers provide multiple, positively charged pyridinium groups, thereby enhancing nucleophilic activity toward OPs as illustrated in the upper path of FIG. 1. Further, the negatively charged halide counter ions (for example, I⁻ and Br⁻) of the pyridinium aldoxime moiety may serve as the substrate for in-situ redox enzyme-catalyzed generation of biocidal halogens as depicted in the lower path of FIG. 1. For example, a system including an oxidase such as glucose oxidase (GOX) and a haloperoxidase such as horseradish peroxidase (HRP) enables the generation of free iodine by tandem redox reactions in the presence of a source of iodide ions and glucose. Free halogens such as iodine are known to kill bacteria.

In the systems studied herein, the oxidase and haloperoxidase enzymes were immobilized. Although enzymatic biocatalysts display high catalytic efficiency and exquisite selectivity, they are, for example, often unstable under harsh environmental and industrial operational conditions. Immobilization provides a strategy to overcome this stability problem and reduces or prevents enzyme loss to the environment. Polymers have, for example, been employed as matrices for enzyme immobilization for their attractive thermo-mechanical and chemical properties. Synthetic polymers are usually the material of choice for enzyme immobilization, though various examples involving the use of natural polymers such as cellulose are described in the literature. Enzyme immobilization can, for example, be achieved by entrapment within the polymer during polymerization, by selective or non-selective adsorption on a polymeric material, or by covalent attachment to a support, each of which can be used for immobilization in the systems hereof (either alone or in any combination). The latter strategy may necessitates either activation of the polymer surface or the modification of the enzyme to enable a covalent enzyme-support connection. Bioplastics including enzymes have been synthesized in either aqueous or non-aqueous media. The choice of the medium for synthesis may influence the amount of enzyme that can be incorporated into the polymer along with its activity retention and stability once immobilized. The formation of protein-containing polymers in the presence of a non-conventional medium may, for example, beneficial in obtaining a viable enzyme-polymer system for utility in organic media.

Once immobilized, the surface area of the enzyme-containing material may have a dramatic effect on activity. One technique to increase or maximize surface area of polymers is electrospinning, which has been employed for the formation of homogenous matrices including, for example, 0.1-1 microns diameter fibers. A benefit of electrospun polymers is the formation of a fairly homogenous population of fibers with relatively high surface area for the entrapment of enzymes, thereby enabling rapid interface reactions that may lead to efficient bioactive coatings. Enzyme-containing, nonwoven mats produced by electrospinning exhibit a high surface area, extreme porosity and good thermal stability. Another benefit of electrospinning (as compared to certain covalent immobilization techniques), when immobilizing an enzyme such as HRP, is that chemical modification of heme-containing proteins can be difficult. In several representative embodiments studied herein, GOX and HRP were entrapped via electrospinning within a non-reactive polyurethane fiber matrix or mesh.

In the studied representative systems hereof, the electrospun mesh or matrix further included a polymer containing multiple positively charged aromatic nucleophiles (such as 4-PAM) with halides as counter ions. In a number of embodiments, the polymer (or the first polymer) containing multiple positively charged aromatic nucleophiles with halides as counter ions was water/aqueous soluble. A second polymer chosen for forming the electrospun matrix was chosen for ease of spinning and to be insoluble in water/aqueous systems. The second polymer prevented the first polymer from dissolving and the enzymes from diffusing away from the system in an aqueous environment. In a number of studies, the first polymer was also covalently linked/crosslinked to the second polymer via, for example, groups on the first polymer which could be converted to radicals via UV energy. The second polymer was also chosen to not interfere with enzyme activity. In the representative studies hereof the second polymer was the medical-grade polyurethane CHRONOFLEX®. Many other polymers are suitable for immobilizing the enzymes and the first polymer via, for example, electrospinning. Such polymers include, for example, other polyurethanes, polyvinylchlorides, polyvinylalcohols, polystyrenes, polyacetylnitriles and cellulosic polymers.

In the case that, for example, an insoluble (aqueous) polymer is used for the first polymer including the aromatic nucleophiles and halides, the first polymer may, for example, be used to immobilize the enzymes. In other embodiments, one or both of the enzymes may be immobilized on the first polymer by, for example, covalent bonding.

The halide counter ions (for example, included in the first polymer) provide a substrate for enzymatically-generated free halogen, and the nucleophiles provide detoxification activity for nerve agents. The positive charge on the nucleophile enhances their detoxification activity. In representative embodiment of a combined polymer matrix hereof, both positively charged nucleophiles and their negatively charged halide counter ions served as complementary components in a multi-functional system/material for decontamination of microorganisms and toxic chemicals. Additionally or alternatively, halide ions can be present as counter ions on other positively charged groups in the polymer (for example, on quaternary ammonium groups). Moreover, either additionally or alternatively, sources of halide ions such as salt crystals or extended release systems for salts (for example, NaI) can be included in systems hereof. For example, in a number of non-optimized studies a salt such as NaI has been placed in hot melt glue or wax to provide a slow, extended or controlled release (that is, providing a release of salt/halide ion over an extended time). Other extended release systems or matrices as known to those skilled in the art may, for example, be used in connection with sources of halide ions.

Further, the nerve agent detoxification component of the composite can also be a delivery vehicle for, for example, therapeutics. In the representative studies, oxime-based (for example, PAM-based) therapeutics were made deliverable by conjugating the oxime groups to the polymer backbone via, for example, degradable or cleavable bonds. In the representative studies hydrolytically metastable ester bonds were used. Hydrolysis of the ester bond releases oxime derivative (4-PAM derivatives, in the representative studies hereof) which can reactivate OP-inhibited AChE. The systems hereof provide broad-spectrum decontaminants both on surfaces and in liquid environments.

It was hypothesized that a polymer containing, for example, multiple quaternary oxime groups would have significantly higher rates of OP nerve agent detoxification than the cognate oxime monomer. Thus, a poly-oxime was designed that included quaternization of the pyridine nitrogen of the oxime to the cationic form of the molecule to take advantage of the enhanced OP reaction rate that results from an increase in nucleophilic activity of aromatic nucleophiles when exposed to high densities of positive charges. The polyquaternary amine nature of the polymer (See FIG. 2, polymer 2), in addition to its activity against OP agents, also provides antimicrobial activity.

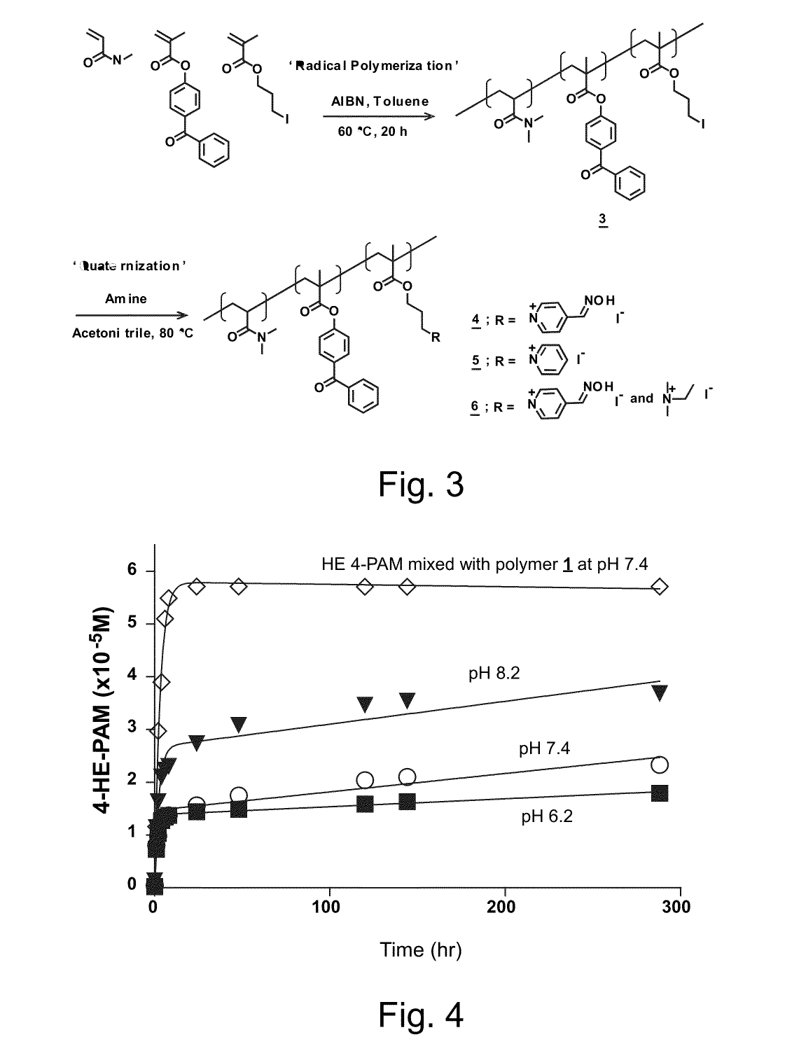

Another aspect of the design of the representative polymer was that the pendant 4-PAM units were connected to the polymer chain through degradable ester linkages. Hydrolysis of the ester bonds was designed to release N-hydroxyethyl 4-Pyridinium aldoxime (FIG. 2, compound 2) that could act as a reactivator of OP-inhibited acetylcholinesterase (AChE). In addition, the halide counter ions (for example, Br⁻ or I⁻) of the quaternary amine groups provided “built-in” substrates for enzymatic redox conversion to active free halogens, which are highly effective antimicrobials. Because 2 is water soluble, derivatives were synthesized with, for example, pendant benzophenone groups (FIG. 3, polymers 3-6) which were used to “immobilize” the water soluble polymers to electrospun polyurethane fibers via photo-activation of the benzophenone groups. Additionally, a polymer with an increased concentration of quaternary amine groups, and consequently with increased halide content, (FIG. 3, polymer 6) was prepared to enhance the halogen production. NMR analysis was used to confirm the composition of the polymers.

The polymers of FIGS. 2 and 3 were prepared from a dimethylacrylamide (DMAA)-methacrylate (MA) co-polymer backbone that contained repeating quaternary 4-pyridinium aldoxime (4-PAM) covalently attached via halo-propionyl side chains. Many other radically polymerizable monomers such as acrylates, methacrylates, acrylamides, methacrylamides can be used in form polymer hereof via radical polymerization. In addition, compounds with vinyl groups could also be used. Polymer formed via synthetic routes other than radical polymerization may also be used. For example, polyurethanes, nylons, polypeptides and other condensation reaction polymerized polymers may, for example, be used.

The nucleophilic activity of 4-PAM is derived from the presence of an oxime group on the pyridinium ring. The oxime group R—CH═N—OH is in equilibrium with its negatively charged oximate anion. Their relative concentrations depend on the oxime pKₐ and the pH of the solution. During detoxification of OP compounds, or reactivation of OP-inhibited AChE, the oximate anion is the active species that attacks the electrophilic phosphorus atom of toxic OPs such as diisopropylfluorophosphate (DFP). Because pKₐ is an important factor in determining the nucleophilic potency of oximes in their reaction with various OPs, pKₐ values of the newly synthesized 4-PAM polymers were determined and compare to the pKₐ's of their respective small molecule 4-PAM precursors.

The pKₐ determined for the 4-PAM bromide polymer 2, 8.45+/−0.02, was similar to the pKₐ of 8.20+/−0.02 measured for its corresponding small molecule N-hydroxy ethyl 4-PAM. The pKₐ of 4-PAM iodide polymer 4 was 8.00+/−0.02 and the pKₐ of the corresponding N-hydroxy propyl 4-PAM bromide and iodide monomers were 8.23 and 8.36 respectively. All linear regression analyses resulted in an excellent fit to the Henderson-Hasselbalch equation (R² from 0.93 to 0.99). The optical density at 280 nm or OD₂₈₀ of polymer 4 was corrected for benzophenone (BP) absorbance (OD₂₈₀=0.100) based on the UV spectrum absorbance of the N,N-dimethylacrylamide-(DMAA)-BP polymer 3, which had an equivalent content of BP (3 mole %) but had no pyridinium.

The pKₐ values measured for the PAM polymers demonstrate a higher nucleophilic activity of the oxime toward OP nerve agents at pH values that were between 8 and 8.5 where the oximate anion is close to 50 mol %. At this range of pKₐ's the Bronsted plot (that describes the dependence of bimolecular rate constant on pKₐ) loses its linearity and the bimolecular rate constant reaches its maximal saturating values. This behavior has been previously reported for oximes.

The N-hydroxyethyl 4-PAM moiety was attached to the backbone of polymer 2 by an ester bond between the hydroxyethyl spacer and the carboxyl group of amino propionate linked to methyl acrylic acid (MA) (see FIG. 2). As described above, the ester bond was designed to be hydrolytically unstable, and to release N-hydroxy ethyl 4-PAM (HE 4-PAM, 7) into the surrounding media. FIG. 4 illustrated the release of HE 4-PAM as a function of time with varying pH. The oxime group 7 released during the first 2 hours from polymer 2 or from its mixture with polymer 1 to the bulk solution. The total quantity of 7 is expressed as milligrams in 75 ml (bulk solution volume). In the studies of FIG. 4, samples of 2 were placed in dialysis cassettes and the dialysate was sampled over time. A mixture of HE 4-PAM bromide 7 with the non-quaternary polymer 1 served as a control for the rate of release and transport of 7 from the inner volume of the dialysis cassette. The concentration of 7 in the dialysates was determined spectrophotometrically based on the molar extinction coefficient of 7 ( [symbol] ₂₈₀=1.5×10⁴ M⁻¹ cm⁻¹). The absorbance values of the dialysate solution were translated into molar concentrations of 7 at each time interval. The rate constants for release at pH 6.2, 7.4 and 8.2, calculated by linear regression of the initial rates, were 0.088, 0.094 and 0.116 hr⁻¹ respectively. The pH-dependent variation in leaching rate was consistent with the reduced stability of ester bonds at basic pH. The rate constant for the release of free monomeric 4-PAM was much more rapid at 0.24 hr⁻¹ indicating that the sustained release of compound 7 from polymer 2 was a result of ester hydrolysis.

The weight % of 7 bound to polymer 2 was 20.8% according to the ¹H-NMR spectrum. Based on this weight % of 7 in polymer 2, the maximum concentration of 7 that could be released from polymer 2 was 5.6×10⁻⁵M. The peak concentration of 7 released to the external buffer (after 288 hours at pH 8.2) was 4.6×10⁻⁵M which corresponds to 82% of the theoretical value.

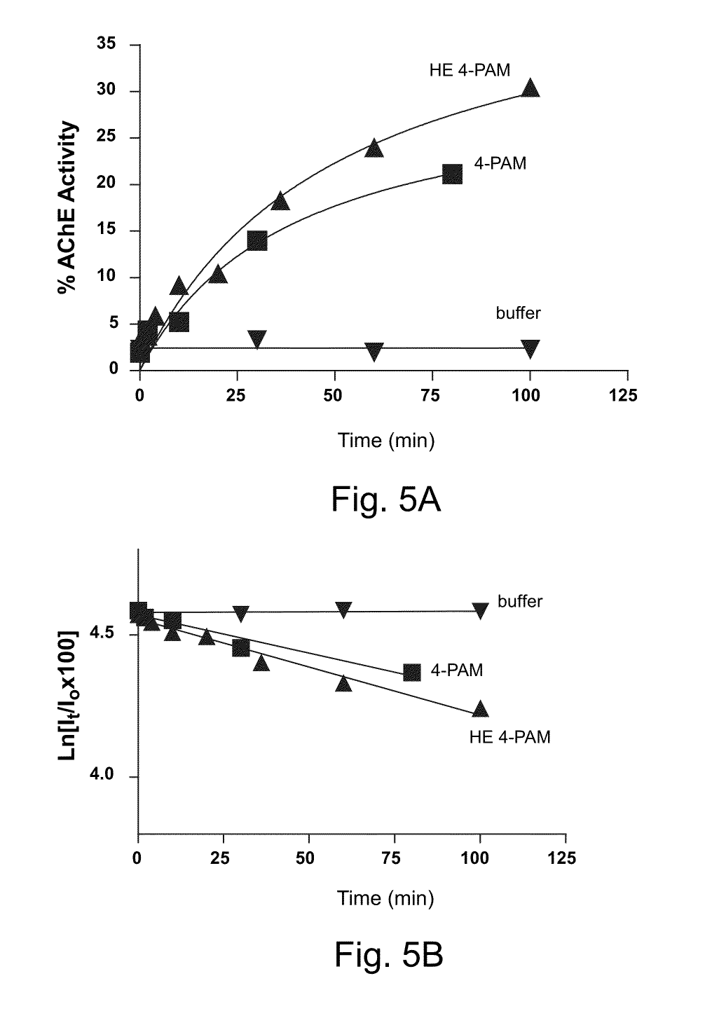

Because the sustained release of 7 from polymer 2 was intended to provide a functional oxime reactivator of DFP-inhibited AChE, it was also demonstrated that 7 was indeed an AChE reactivator. In several studies, a sample of AChE was inhibited by DFP (10 μM) to create a stable diisopropyl phosphoryl-AChE conjugate with 97% inhibition of the initial enzymatic activity of AChE. The inhibited AChE was incubated with either 7 or 4-PAM iodide (0.4 mM each). The rates of reactivation of DFP-inhibited AChE by 7 and 4-PAM were calculated from the decrease of AChE relative inhibition with time (see FIG. 5A). Rate of decrease in AChE inhibition during reactivation is set forth in FIG. 5B. The k_{obs} for 7 and 4-PAM (0.4 mM) were 2.7×10⁻³ and 3.4×10⁻³ min⁻¹ respectively, and were similar to those previously reported for 4-PAM with DFP-inhibited AChE. The reactivation levels obtained after 24 hours were 70% of the initial AChE activity. Without limitation, the 30% activity loss was likely a result of a known aging process that produces a dealkylated, non-reactivatable diisopropyl phosphoryl-AChE conjugate. Spontaneous reactivation of DFP-inhibited AChE in buffer was less than 2% after 24 hours.

The above results indicate that 7 was a reactivator of OP inhibited AChE. Peak levels of hydrolytically released 7 were obtained after 288 hours. It is anticipated that the rate of hydrolysis may be enhanced in vivo by the activity of endogenous esterases, further increasing the therapeutic utility of polymer 2.

As described above, electrospinning of polymers offers a versatile method to produce non-woven mats composed of nanofibrous materials. Incorporation of enzymes into polymers through electrospinning provides desirable features for biocatalysis such as large surface areas for enzyme display, enhanced mass transfer rates of substrate to the enzyme active site, and an enzyme-polymer matrix suitable for multiple challenges. Additionally, electrospinning water soluble materials with water insoluble materials can immobilize the soluble material within a stable matrix as a surface coating.

To test the ability of the polymers hereof to act as surface decontaminating agents, the water soluble polymers 2 and 4 (5% w/v) were electrospun with the water insoluble medical grade polyurethane CHRONOFLEX® (CF), generating the composite materials CF-2 and CF-4. The electrospinning resulted in homogenous, elastomeric, fiber mats. These electrospun fiber mats were assayed for DFP detoxification capacity, free iodine and bromine generation, and bactericidal activity.

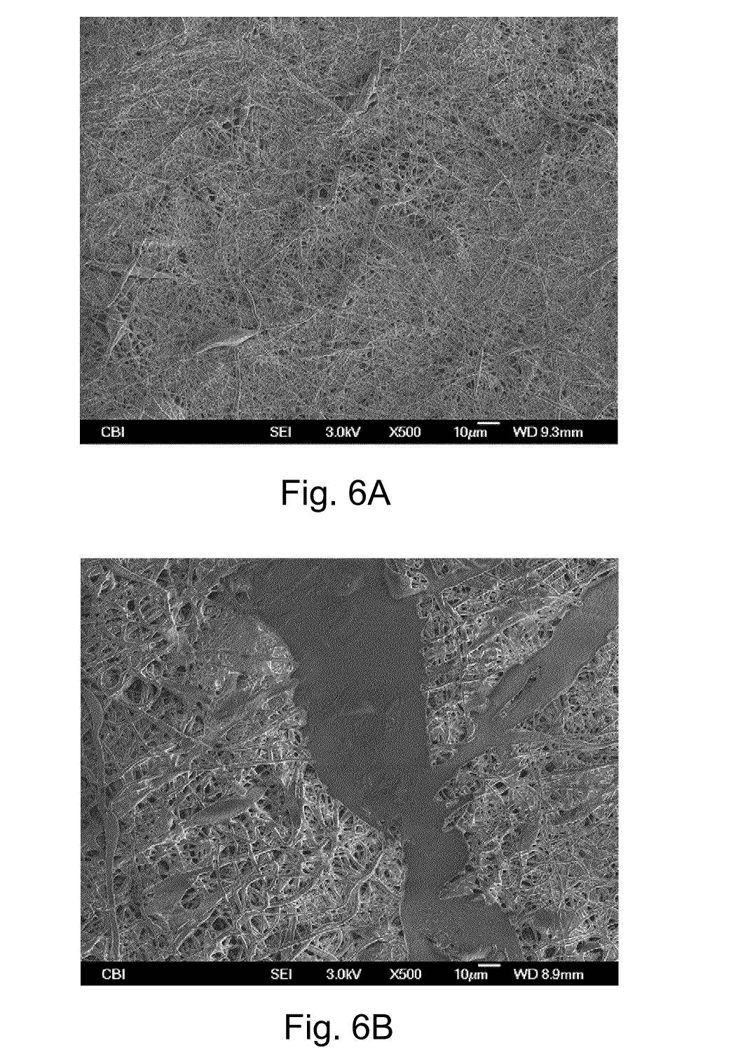

Electrospinning does not create covalent linkages between nonreactive polymer chains such as polyurethanes and acrylates. This means that the water soluble acrylates are entrapped within the polyurethane and can still leach out from the matrix. To limit this leaching, four polymers were designed to contain a benzophenone moiety to allow UV-induced cross-linking of the soluble polymer to polyurethane (see FIG. 3). Photo-activated cross-linking was performed using UV irradiation on polymer mat samples wetted with acetone. Scanning electron microscopy (SEM) pictures of electrospun CF-4 fibers before UV irradiation and after 5 minutes UV irradiation are illustrated in FIG. 6A and FIG. 6B, respectively. The fibers of the electrospun polymer in FIG. 6A were spread evenly whereas gaps in the fiber morphology were observed following UV irradiation (FIG. 6B).

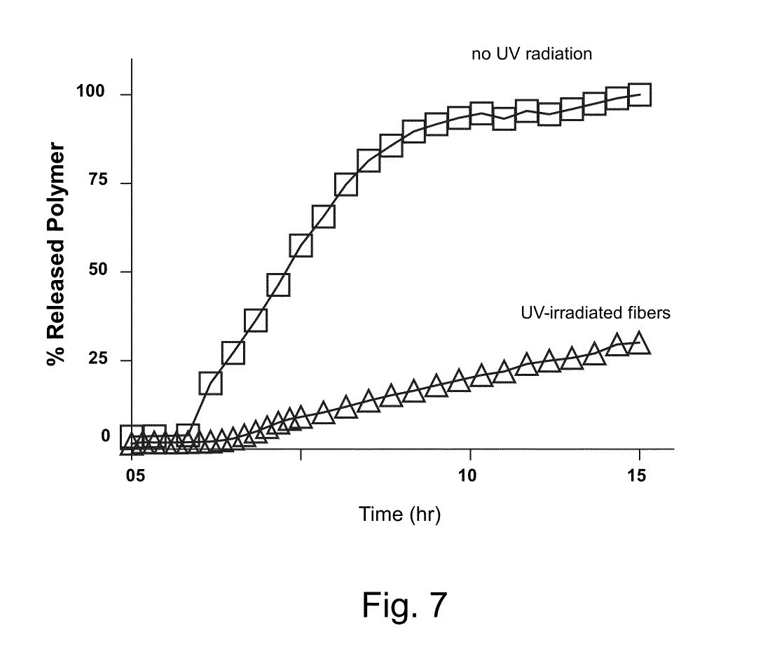

To determine the mobility of the 4-PAM polymers within the electrospun matrices, CF-4 and UV cross-linked CF-4 fibers (5 mg) were placed in 1 ml of 50 mM phosphate buffer (pH 6.2). The absorbance of the pyridinium aldoxime group at 280 nm was measured continuously for 15 hrs at 22° C. (FIG. 7). Leaching was observed in both sets of fibers within the first 2 hours with virtually all of the polymer 4 leached from the non-crosslinked fibers within 8 hours (FIG. 7). While there was leaching of polymer 4 from the crosslinked fibers the leaching rate was 6.8 fold lower than that of the non-crosslinked fibers.

Polymers 1, 2, and 4 were mixed with CF polyurethane and electrospun together with the redox enzymes GOX and HRP to produce fibers of CF-1-GOX-HRP, CF-2-GOX-HRP and CF-4-GOX-HRP. Homogenous mats of electrospun fibers were used to assess bactericidal activity and DFP detoxification.

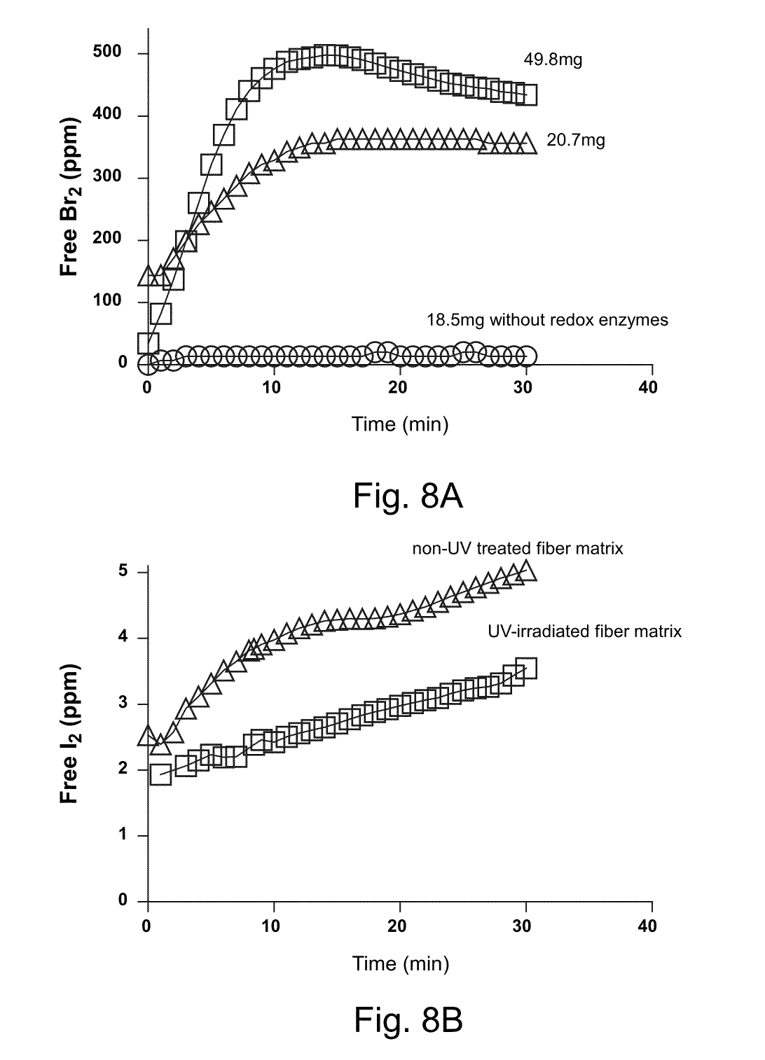

PAM-halide polymers, 2 and 4 were shown to contain halide anions at 10-12% w/v as determined by ¹H-NMR analysis. Weighed amounts of fibers were immersed in cuvettes containing phosphate buffer. Free halogen generation was initiated by the addition of glucose (5 mM to approximate its physiological concentration) into the buffer containing the immersed fibers, and the rate of halogen evolution was detected by a chromogenic reaction with PVA. Based on calibration curves prepared for bromine and iodine, bromine was generated at 500 to 1,000 ppm and iodine at 4 to 5 ppm steady state concentrations (see FIGS. 8A and 8B respectively). These levels are significantly above the minimal inhibitory concentrations (MIC) of iodine and bromine for bactericidal activity against S. aureus (0.1 and 28 ppm, respectively) and E. coli (0.6 and 4.3 ppm, respectively) indicating that the materials would be effective antimicrobials.

Polymer 2 and its non-quaternary precursor polymer 1 were electrospun with CF, GOX, and HRP. Samples of the electrospun fibers were incubated with bacteria in the presence of glucose (5 mM). The CF-2-HRP-GOX sample killed >6 logs of E. coli within 1 hr at 37° C. (Table 1). As expected, since the non-quaternary polymer 1 carries with it no halide counter-ions, E. coli cells incubated with CF-1-GOX-HRP survived. CF-4,-GOX-HRP fibers together with NaI and glucose in solution also killed all of E. coli within 1 hr (see Table 1 below). The benzophenone in CF-4-HRP-GOX fibers did not affect the bactericidal activity, even after cross-linking the fibers by UV irradiation, suggesting that the enzyme activity was not affected by either the UV light or the cross-linking reaction. Polymer 6 included dimethyl ethyl propyl ammonium moieties in addition to the 4-PAM groups providing additional halide ions to increase the rate of enzyme catalyzed generation of halogen. CF-6 fiber (with GOX, HRP, and glucose in solution) was an effective biocide against both E. coli and S. aureus (see Tables 1 and 2). A significant bactericidal activity of polymer 6 was observed with S. aureus even without the redox enzymes (reduction of 2 log units, Table 2). This result is consistent with the known antimicrobial activity of high density positively charged quaternary ammonium polymers as found in polymer 6 when compared to the lower density of quaternary amine groups in polymer 4.

TABLE 1
Bactericidal activity of 4-PAM polymers electrospun with polyurethane CF
fibers. against E. coli

| | Polymer | | | | | |
|---|---|---|---|---|---|---|
| | in | | Enzyme(s) | Glucose | NaI | Number of |
| Sample | solution | Electrospun fibers¹ | in solution | (mM) | (mM) | Surviving Cells² |
| 1 | 1 | — | — | 5 | 0 | 4.4 +/− 1.4 × 10⁶ |
| 2 | 1 | — | GOX | 5 | 0 | 3.8 +/− 0.1 × 10⁶ |
| 3 | — | CF-1-GOX-HRP | — | 5 | 0 | 9.1 +/− 0.7 × 10⁶ |
| 4 | — | CF-2-GOX-HRP | — | 5 | 0 | 0 |
| 5 | — | CF-2-GOX-HRP | — | 0 | 0 | 6.0 +/− 2.0 × 10⁶ |
| 6 | — | CF-4-GOX-HRP | — | 5 | 0 | 0 |
| 7 | — | CF-4-GOX-HRP | — | 5 | 0 | 0 |
| | | UV irradiated³ | | | | |
| 8 | — | CF-4 | GOX/HRP | 5 | 0 | 0 |
| 9 | — | CF-4 UV | GOX/HRP | 5 | 0 | 0 |
| | | irradiated³ | | | | |
| 10 | — | CF-6 | GOX/HRP | 0 | 0 | 2.0 +/− 0.1 × 10⁶ |
| 11 | — | CF-6 | GOX/HRP | 5 | 0 | 0 |
| 12 | — | — | GOX/HRP | 5 | 0.8 | 0 |

¹Fiber weights were 12-15 mg.
²Bactericidal activity was measured after 60 min incubation in 2 ml phosphate buffer pH 6.2, at 37° C. containing 9.1 +/− 0.7 × 10⁶ E. coli for samples 1-9 and 2.0 +/− 0.1 × 10⁶ for samples 10-12.
³Fibers were UV irradiated at 330-360 nm for 20 min prior to antimicrobial testing.

TABLE 2
Bactericidal activity of polymer 6 electrospun with CF polyurethane,
HRP and GOX. against S. aureus

| Sam- | Electrospun | Enzyme(s) | Glucose | NaI | Number of |
|---|---|---|---|---|---|
| ple | fibers¹ | in solution | (mM) | (mM) | Surviving Cells² |
| 1 | CF-GOX-HRP | — | 5 | 0 | 1.2 +/− 0.1 × 10⁴ |
| 2 | CF | — | 5 | 0.8 | 2.3 +/− 1.4 × 10⁵ |
| 3 | CF-6 | — | 5 | 0 | 9.8 × 10³ |
| 4 | CF-6-GOX/HRP | — | 5 | 0 | 0 |
| 5 | — | GOX/HRP | 5 | 0.8 | 0 |

¹Fiber weights were 12-15 mg
²Bactericidal activity was measured after 60 min incubation in 2 ml phosphate buffer pH 6.2, at 37° C. containing 2.5 × 10⁵ S. aureus.

The reaction of DFP with quaternary oximes proceeds by nucleophilic attack of the oximate anion on the electrophilic phosphorus atom creating an unstable phosphoryl-oxime product. The direct reaction of oximes with OP compounds in solution is usually very slow. Based on the positive charge effect that can enhance the nucleophilicity of aromatic oximes it was of interest to study the reaction rate of the poly-quaternary oxime polymers with DFP. DFP detoxification as a function of pH was measured by incubating 5 μM DFP with either soluble polymers 2 or 4 or electrospun fibers of those polymers within polyurethane in phosphate buffer. Analysis of the residual concentration of DFP was performed by measuring the residual activity of butyrylcholinesterase (BChE) which had been treated with DFP for 3 minutes at a final concentration of 4×10⁻⁷ M.

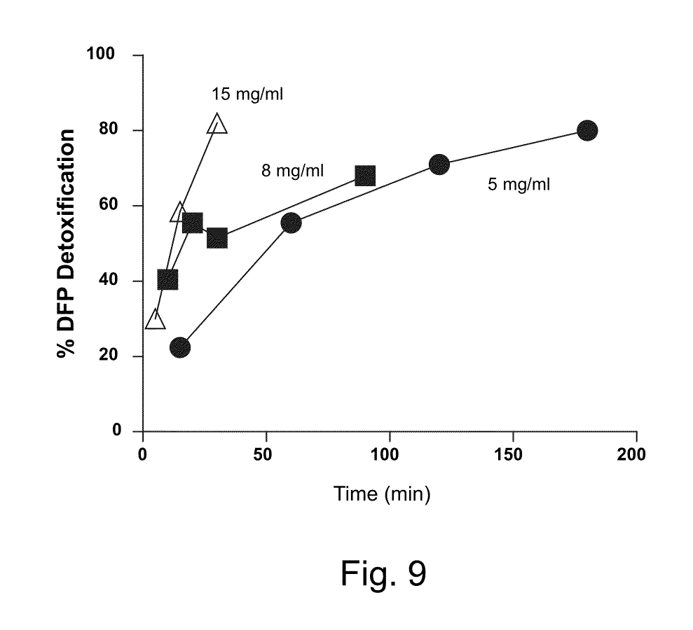

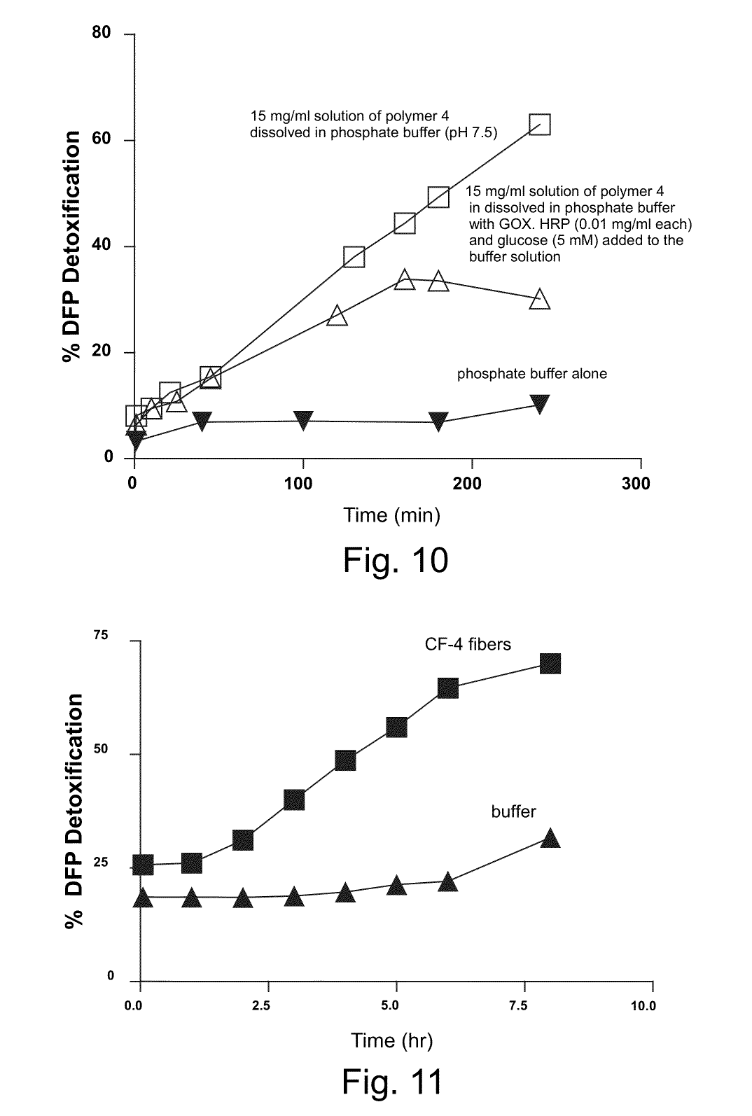

The rate of DFP detoxification by soluble polymer 2 was dose-dependent and reached 80% DFP degradation within 30 minutes at 15 mg/ml 2 (see FIG. 9). The same level of degradation was obtained after 3 hours with polymer 2 at 5 mg/ml (FIG. 9) indicating dose-dependence of DFP detoxification by the oxime polymer. The degree of DFP detoxification by soluble polymer 4 reached 35% after 3 hours (FIG. 10). Interestingly, addition of GOX/HRP and glucose to this solution enhanced DFP hydrolysis by soluble polymer 4 to 60% within 4 hours (FIG. 10). Without limitation to any mechanism, it was likely that the rate enhancement was achieved by an oxidation mechanism mediated by the free halogen or the peroxide produced by GOX.

With CF-4 80%, DFP detoxification was achieved after ten hours (see FIG. 11). Although the rate of DFP detoxification by the electrospun material was slower than soluble polymer 4 it was significantly faster than phosphate buffer alone. The rate of CF-4 induced detoxification could be improved by, for example, simply reformulating the component ratios in the electrospinning.

The importance of the nucleophilic activity of the oximate anion was observed by performing the DFP degradation at pH 6.2. DFP was only marginally degraded (10%) by polymer 4 after four hours. The oximate anion was responsible for detoxification since its nucleophilic activity increased under more basic conditions (pH=7.5). DFP detoxification was also performed at pH 7.5 with pyridinium iodide polymer 5 that contained no oxime groups. The extent of DFP detoxification by polymer 5 was less than 10% after 4 hours, showing again that the oxime group was responsible for the detoxification activity of the polymer 4.

The systems hereof, which include at least one oxidase, at least one haloperoxidase, and a polymer having groups exhibiting nucleophilic activity for organophosphorus compounds and halide ions, provide a multifunctional system for decontamination of biological and chemical warfare agents. The decontaminating activity of the systems hereof is based upon decontamination of OP nerve agents via the groups exhibiting nucleophilic activity for toxic organophosphorus/organophosphate compounds (for example, oxime groups) and enzymatic generation of reactive halogens as a bactericide.

In the representative studies set forth above, detoxification of DFP was achieved. The representative polymeric oxime of the representative systems exhibited enhanced activity toward DFP compared to small molecule oximes. DFP detoxification by the oxime (PAM) polymers was pH-dependent indicating that the oximate anion was the reactive moiety in attacking the electrophilic phosphorus atom in DFP releasing the fluoride anion. The redox enzymes GOX and HRP, in conjunction with oxime-halide polymers (for example, either soluble or electrospun as one integrated matrix), killed E. coli and S. aureus efficiently. The introduction of additional positively charged aliphatic quaternary ammonium groups (polymer 6) caused a parallel increase in halide content which provided a higher substrate level for HRP. A partial non-enzymatic biocidal activity was observed with polymer 6 (2 log units S. aureus) stemming from the increase in density of quaternary ammonium groups. Polymers containing the AChE reactivator compound, 7, conjugated to the polymer backbone via an hydrolysable ester linkage were synthesized. The oxime reactivator 7 was shown to be released from the polymer and to reactivate DFP-inhibited AChE. The representative systems decontaminate both chemical and biological agents without cross interference with either process. Indeed, the activity primarily directed at the biological agents may even enhance the chemical decontamination.

Experimental Methods

Materials

Horseradish peroxidase (HRP) (1500 U/mg) and Aspergillus niger glucose oxidase (GOX) (100 U/mg), butyrylcholinesterase (BChE) (horse serum, 1690 u/mg), acetylcholinesterase AChE (electric eel 250 U/mg), iodine, bromine, sodium iodide, sodium bromide, partially saponified (87%) polyvinyl alcohol (PVA), hexafluoroisopropanol (HFIP) and glucose were purchased from Sigma St Louis Mo. Medical grade polyurethane CHRONOFLEX AR is a product of AdvanSource Biomaterials Corp, Wilmington, Mass.

γ-Aminobutyric acid, p-toluenesulfonic acid monohydrate (TosOH), methacryloyl chloride, 2-bromoethanol, N,N,N-triethylamine (TEA), N,N-dimethylacrylamide (DMAA), 2,2′-Azobis(2-methylpropionitrile) (AIBN), 4-pyridinealdoxime (4-PAM), 3-iodopropanol, 4-hydroxybenzophenone, pyridine, N,N-dimethylethylamine (DMEA), 3-bromopropanol, toluene, diethyl ether, 2-propanol, ethanol, dichloromethane (CH₂Cl₂) and acetonitrile were purchased from Sigma-Aldrich Chemical Co (St Louis Mo.).

Synthesis of Multifunctional Decontamination Polymers

Polymers were prepared from a dimethylacrylamide (DMAA)-methacrylate (MA) co-polymer backbone that contained repeating quaternary 4-pyridinium aldoxime (4-PAM) covalently attached via halo-propionyl side chains.

FIG. 2 describes the strategy for synthesis of DMAA MA-3-Propionyl-ethyl 4-PAM bromide (polymer 2). The precursor polymer DMAA-MA-3-propionyl ethyl bromide 1 was synthesized by radical polymerization from the corresponding monomers. Following the co-polymerization of DMAA with MA-propionyl bromide ester monomers, the bromo-ethyl-propionyl side chains of polymer 1 were reacted with 4-pyridine aldoxime to form the quaternary 4-PAM polymer 2. The quaternary polymer product 2 contains N-hydroxy ethyl 4-Pyridinium aldoxime units (7, FIG. 2) tethered to the polymer backbone through ester bonds. The ester bonds connecting 7 (N-HE-4-PAM, scheme 2,) to the polymer backbone are prone to spontaneous or enzyme-induced hydrolysis rendering polymer 2a macromolecular carrier for sustained drug delivery (see release of 7 in FIG. 2).

FIG. 3 describes the synthetic pathway to four co-polymer structures. First, a non-quaternary co-polymer backbone containing propyl iodide side chains and benzophenone DMAA-MA propyl iodide-MA propyl 4-pyridinium aldoxime MA benzophenone 3 was prepared by radical polymerization. Subsequently, the 3-iodopropyl side chains on the polymer were reacted with 4-pyridine aldoxime to form the 4-PAM quaternary polymer 4. The introduction of benzophenone (at 3.2 mole %) into the polymer chains of 3 and 4 was performed to achieve photo-activated cross-linking of the soluble polymer with polyurethane after electrospinning. This synthetic approach yielded polymer with 78.2% of DMAA, 13.7% of 4-PAM iodide, 1.5% of propyl iodide (that did not react with 4-pyridine aldoxime), and 3.2% benzophenone subunits as evaluated by ¹H-NMR analysis.

FIG. 3 also describes the synthesis of a polyquaternary amine including the positively-charged N-hydroxy propyl-pyridinium moiety 5. Since the pyridinium moiety in this polymer lacks any active nucleophile, this polymer was primarily prepared as a reference polymer to distinguish the role of the nucleophilic oxime group in the 4-PAM co-polymer for scavenging OP compounds (for example, DFP).

To increase the density of positively charged quaternary nitrogen (and that of the associated halide counter ion) polymer 6, poly-DMAA MA-propyl 4-PAM iodide MA-propyl-dimethyl-ethyl ammonium iodide MA-benzophenone, was prepared as illustrated in FIG. 3. ¹H-NMR analysis determined that polymer 6 contained 15.4% w/w iodide.

Measurement

¹H-NMR spectra were recorded on a Bruker Avance (300 MHz) spectrometer in DMSO-d₆ and CDCl₃. Routine FT-IR spectra were obtained with ATI Mattson Infinity series FTIR spectrometer. Melting points (mp) were measured with a Laboratory Devices MeI-Temp. Number average molecular weights (Mₙ) and the distributions (M_{w}/Mₙ) were estimated by gel permeation chromatography (GPC) on a Water 600E Series with a data processor, equipped with three polystyrene columns (Waters styragel HR1, HR2 and HR4), using DMF with LiBr (50 mM) as an eluent at a flow rate 1.0 mL/min, polymethylmethacrylate calibration, and a refractive index (RI) detector.

Determination of Polymer pKₐ

Polymer pKₐ's were determined by a spectrophotometric method. At each specified pH the ratio of absorbance of oximate anion (at 345 nm) to that of oxime group (at 280 nm) was measured. The OD₃₄₅/OD₂₈₀ ratio equals the [Ox⁻]/[OxH] ratio at a given pH. The pH values were plotted against log [Ox−/OxH] and the pKₐ was calculated from the intercept of the linear plot with the ordinate using the Henderson-Hasselbalch equation (Eq. 1 below):

pH=pKₐ+log [Ox−]/[OxH] (Eq. 1)

The UV/visible spectra of 4-PAM bromide polymers were scanned at various pH's (ten solutions with pH's ranging between 7.4-10.3 in 50 mM Tris-HCl buffer using 0.05 mg/ml polymer concentration).

Release of N-hydroxyethyl-4-pyridinium Aldoxime from Polymer 2

Release of N-hydroxyethyl 4-pyridinium aldoxime bromide from polymer 2 was measured at 37° C. in phosphate buffer at pH 6.2, 7.4 and 8.2. 30 mg of polymer 2 was dissolved in 3 mL of deionized water. 500 μL of the polymer solution was injected into dialysis cassettes with a molecular weight cutoff of 2,000 (ThermoScientific, Rockford, Ill.). The dialysis cassette was placed in a beaker containing in 75 mL of buffer and shaken at 37° C. Absorption of the dialysates at 280 and 340 nm were recorded over time using a Lamba 2 spectrometer (Perkin Elmer).

Enzymatic Free Iodine Formation

The rate of free iodine formation, catalyzed by enzymatic oxidation, was measured by the addition of the enzymes GOX and HRP (10 μl of 1 mg/ml, each), NaI solution (20 μl, 0.04 M), 0.1 ml polyvinyl alcohol (PVA, 1% w/v in water), and 0.1 ml of 50 mM glucose into 50 mM phosphate buffer pH 6.2. The increase in absorbance at 490 nm arising from PVA-I₂ complex formation was measured continuously. The rate of increase in the concentration of iodine was also measured by replacing the enzyme solutions with solid samples (1-30 mg) of electrospun fiber in which the enzymes GOX and HRP were entrapped in the polyurethane CHRONOFLEX AR.

Electrospinning of Polyurethane Fibers with and without Enzymes

CHRONOFLEX AR (CF) and the polymers 1, 2, (FIG. 2) and 4 (FIG. 3) were dissolved in hexafluoroisopropanol (HFIP) at 5% w/v to form the materials CF-1, CF-2 and CF-4. Electrospining of CF-copolymers fibers was performed by streaming an HFIP solution of the mixed polymers from a 1 ml syringe using a syringe pump (Aladdin Programmable Syringe Pump-AL1000) at a rate of 1 ml/hr. The polymer solution then entered a stainless steel capillary (20 gauge, 2 cm long). Fibers were collected on aluminum foil at a 30 kV voltage drop (+18 kV at the capillary and −12 kV at the collection plate) for 30 minutes. When GOX and HRP were incorporated into the electrospinning process the resultant materials were CF-1-GOX-HRP, CF-2-GOX-HRP, and CF-4-GOX-HRP. The enzymes were dissolved at 10 mg/ml in phosphate buffer pH 6.2 and placed in a 1 ml syringe and driven at a rate of 0.33 ml/hr in parallel to the polymer solution flowing at 1 ml/hr. The tubing from the syringes was connected at a Y-junction immediately ahead of the metal capillary. The end of the capillary was 20 cm above the collection plate.

Scanning Electron Microscopy (SEM)

Small samples of the fiber mats were cut and sputter coated with gold particles. Samples were analyzed in a JSM6330F scanning electron microscope at magnifications varying from 300×-1500×. The entire surface was scanned to view the uniformity of fibers.

Bactericidal Activity of Fibers

Electrospun fiber materials were immersed in 2 ml sterile phosphate buffer (pH 6.2). Depending on the experimental conditions, solutions contained sodium iodide (0.8 mM) and/or glucose (5 mM). For fibers electrospun without enzymes, GOX and HRP were added to the buffer solution (0.01 mg/ml final concentration). E. coli or S. aureus was added to the reaction mixture to a final concentration of 3-7×10⁷ or 2-5×10⁵ cells/ml, respectively. Reaction mixtures were shaken for either 0.5 hr or 1 hr at 37° C. The reaction was stopped by serial dilution into 0.3 mM phosphate buffer (pH 7.2) followed by seeding on nutrient agar plates and overnight incubation at 37° C. to determine the number of surviving cells.

Detoxification of DFP by Polymers

Polymers, either soluble or incorporated in polyurethane fibers by electrospinning, were incubated in the presence of DFP (5 μM) in phosphate buffer (pH 7.5). DFP detoxification by polymer 4 was also tested in HEPES buffer (pH 8.1 or 9.0). Samples of the hydrolyzed DFP (20 μl) were added to horse serum BChE (2 U/ml, 230 μl) for 3 minutes at 22° C. The inhibited BChE was sampled (30 μl) into a 1 ml cuvette containing Ellman's reagent DTNB and acetylthiocholine (ATC, 0.3 mM). Residual BChE activity was determined by measuring the change in OD₄₁₂. The rate of detoxification of DFP was calculated from the temporal increase in BChE activity caused by degradation of DFP by the 4-PAM polymer.

Reactivation of AChE

Electric eel AChE (0.5 mg/ml in 50 mM phosphate, 0.1% BSA, pH 7.5) was diluted in phosphate/BSA buffer to provide appropriate starting activity. AChE (20-fold dilution of AChE stock) was reacted with 10 μM DFP for 1 hr at 22° C., and further diluted 50 fold into a cuvette containing a mixture of ATC and DTNB in phosphate buffer (pH 7.50). The degree of AChE inhibition by DFP prior to reactivation was between 97-98%. The DFP-inhibited AChE (diisopropyl phosphoryl-AChE) was diluted 1:50 and incubated for specified time intervals with N-hydroxyethyl 4-pyridinium aldoxime bromide (HE 4-PAM, 7 scheme 2) or 4-PAM iodide at 0.4 mM. The diisopropyl phosphoryl-AChE conjugate was also incubated in phosphate buffer (pH 7.5) without oxime to determine the spontaneous reactivation rate. Aliquots of diisopropyl phosphoryl-AChE from the oxime solution or phosphate buffer were taken at various time intervals and AChE activity was determined.

The foregoing description and accompanying drawings set forth the preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

What is claimed is:

1. A system comprising:
at least one oxidase;
at least one haloperoxidase;
at least first polymer comprising groups exhibiting nucleophilic activity for organophosphorus compounds;
and a source of halide ions to serve as a substrate for haloperoxidase-catalyzed generation of halogens.

2. The system of claim 1 wherein the source of halide ions comprises salt crystals or a salt in an extended release system.

3. The system of claim 1 wherein the first polymer comprises halide ions.

4. The system of claim 1 wherein the oxidase is glucose oxidase.

5. The system of claim 1 wherein the haloperoxidase is horseradish peroxidase.

6. The system of claim 1 wherein the oxidase and the haloperoxidase are incorporated within a polymeric matrix including at least a second polymer.

7. The system of claim 6 wherein the oxidase and the haloperoxidase are electrospun from a solution including the second polymer.

8. The system of claim 7 wherein the solution also includes the first polymer.

9. The system of claim 7 wherein the first polymer and the second polymer are electrospun into a nonwoven matrix.

10. The system of claim 1 wherein the groups exhibiting nucleophilic activity include an oxime group.

11. The system of claim 10 wherein the groups exhibiting nucleophilic activity include at least one group having the formula: 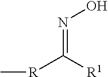
wherein R is an aryl group and R¹ is H or a C₁-C₁₅ alkyl group.

12. The system of claim 11 wherein R includes a quaternary ammonium group.

13. The system of claim 12 wherein the groups exhibiting nucleophilic activity include at least one group have the formula: 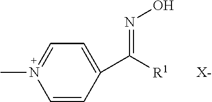
wherein X is a halide ion.

14. The system of claim 13 wherein X is Br or I.

15. The system of claim 13 wherein the groups exhibiting nucleophilic activity are attached to the first polymer via a degradable or cleavable group.

16. The system of claim 1 wherein the groups exhibiting nucleophilic activity are attached to the first polymer via a degradable group or cleavable group.

17. The system of claim 16 wherein the degradable group is a group adapted to undergo hydrolysis.

18. The system of claim 13 wherein the first polymer further comprises groups adapted to form a reactive radical upon application of energy.

19. The system of claim 18 wherein the groups adapted to form a reactive radical upon application of energy include benzophenone-, acetophenone-, benzyl-, benzoin-, hydroxyalkylphenone-, phenyl cyclohexyl ketone-, anthraquinone-, trimethyl-benzoylphosphine oxide-, methylthiophenyl morpholine ketone-, aminoketone-, azobenzoin-, thioxanthone-, hexaarylbisimidazole-, triazine-, or fluoroenone-.

20. The system of claim 13 wherein the first polymer is the reaction product of a radical polymerization of radically polymerizable monomers.

21. A polymer comprising: groups exhibiting nucleophilic activity for organophosphorus compounds and halide ions.

22. The polymer of claim 21 wherein the groups exhibiting nucleophilic activity include an oxime group.

23. The polymer of claim 22 wherein the groups exhibiting nucleophilic activity include at least one group having the formula: 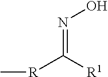
wherein R is an aryl group and R¹ is H or a C₁-C₁₅ alkyl group.

24. The polymer of claim 23 wherein R includes a quaternary ammonium group.

25. The polymer of claim 23 wherein R is a pyridinium group such that the groups exhibiting nucleophilic activity include at least one group have the formula: 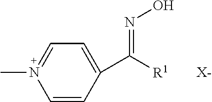
wherein X is a halide ion.

26. The polymer of claim 25 wherein X is Br or I.

27. A method of providing for decontamination of both organophosphorus compounds and biological agents: comprising providing a system comprising at least one oxidase, at least one haloperoxidase, at least a first polymer comprising groups exhibiting nucleophilic activity for organophosphorus compounds; and a source of halide ions to serve as a substrate for haloperoxidase-catalyzed generation of halogens.
